(19) United States
(12) Patent Application Publication
(10) Pub. No.: US 2024/0050939 A1
(43) Pub. Date: Feb. 15, 2024

(54) DEVICE FOR EFFICIENT MEDIUM EXCHANGE IN MICROTITER PLATES

(71) Applicant: HEINRICH-HEINE-UNIVERSITÄT DÜSSELDORF, Düsseldorf (DE)

(72) Inventors: Knud ESSER, Köln (DE); Andrea KULIK, München (DE)

(21) Appl. No.: 18/283,908

(22) PCT Filed: Mar. 25, 2022
(86) PCT No.: PCT/EP2022/057906

§ 371 Date: Sep. 25, 2023

(30) Foreign Application Priority Data
Mar. 25, 2021 (DE) 10 2021 107 590.4

(51) Int. Cl. B01L 3/00

(52) U.S. Cl. CPC B01L 3/5025; B01L 2200/0642; B01L 2400/0409; B01L 2300/0829; B01L 2200/025

(57) ABSTRACT

A device for the simultaneous filling of microtiter plate wells via centrifugal forces. In an implementation, the device includes a planar attachment for a microtiter plate having one or more liquid reservoirs for filling one well each of the microtiter plate per liquid reservoir. Each liquid reservoir has an upper filling opening for receiving a filling liquid, one or more lower filling nozzles for dispensing the filling liquid into the well of the microtiter plate, and a reservoir wall which connects the filling opening and the filling nozzle to one another. The filling nozzle is arranged off-center to the axis of symmetry of the microtiter plate well and off-center to the axis of symmetry of the filling opening of the filling device in a subregion of the reservoir wall.

### INTRODUCTION

The present disclosure relates to a device for simultaneous filling of microtiter plate wells by way of centrifugal forces.

The great progress and speed of research in the livescience field in recent decades can be attributed in particular to the improvement of experimental techniques. One milestone, for example, is the development of high-throughput screening, which allows simultaneous processing of a large number of different samples by means of specially adapted test devices. Another advantage of this approach is that the individual tests have been adapted to sample sizes that allow a significant statement regarding the test result despite the use of only very small amounts of substances. In this respect, high-throughput screening not only saves time, but also costs. The use of microtiter plates has established itself in many laboratories as the standard reaction vessel, with the actual reaction being carried out in the individual wells of the plates. Depending on the number of wells, 6, 96 or even up to 3456 individual tests can be performed simultaneously in a very small space. The filling volume, and thus the size of a test batch, of the individual well can vary between 5000 μl and 1 μl depending on the number of wells. It goes without saying that, in addition to the microtiter plates, the other experimental devices must also be adapted to the respective size of the individual preparation and the quantity of different preparations. For example, special multichannel pipettes were developed that allow the simultaneous filling of several wells. Multi-channel designs have also been developed in the field of analytical instruments, which allow the simultaneous, parallel measurement of a physical parameter of several individual wells. Despite the progress achieved in the handling of microplates, the disadvantage remains that the simultaneous preparation of a large number of test sets can be time-consuming and error-prone.

Some embodiments for supplying multiwell plates with liquid media can also be found in the patent literature.

For example, U.S. Pat. No. 10,704,016 B2 describes a multiwell plate having a plurality of wells for spreading at least one microtissue, each of the plurality of wells comprising an upper portion having an upper well opening, a lower portion having a closed well bottom, and a single constriction from the top opening to the closed well bottom, wherein the constriction consists of an intermediate portion disposed between the upper portion and the lower portion; wherein the upper section and the lower section are in fluid communication, and wherein the lower section of each well has a smaller cross-sectional area than the upper section of the same well; wherein the lower section is eccentrically disposed with respect to the longitudinal axis of the upper section of each well, the intermediate section further comprising a pipetting stage and a chute, wherein the pipetting stage and the chute are contained within the single constriction of the well, wherein the pipetting stage has a slope and the chute is provided between the pipetting stage and the lower section, and wherein the chute has a gradually increasing slope, the slope being greater than the slope of the pipetting stage.

In another patent document, WO 2013 012 588 A1, an adapter for connecting a multi-channel air displacement pipette to an array of pipette tips is disclosed, the pipette tips having through-holes with tapered top ends and the pipette having a plurality of openings with compliant inner sealing surfaces, the adapter comprising: a planar base having an array of openings extending between the top and bottom of the base; sealing tubes projecting upwardly from the top; and tip attachment tubes projecting downwardly from the bottom, wherein pairs of sealing tubes and tip attachment tubes are coaxially and internally disposed; communicating with respective openings in the base, the tip attachment tubes being externally sized and configured for insertion into the tapered top ends of the pipette tips, and the seal tubes being externally configured and sized for insertion into the ports of the pipette and into the sealing surfaces with the compliant internal sealing surfaces.

Further, EP 0 843 176 A1 describes a container comprising a slit part formed at an inner lower part of the container to have a width smaller than a caliber of a front end portion of a liquid suction/discharge pipe adapted to be to be inserted into and withdrawn from said container, said split part being formed to have a shape capable of sucking and discharging the entire amount of liquid through said front end portion even in a state in which said front end portion is disposed in contact with said inner lower part.

Such solutions known from the prior art may offer further potential for improvement, especially with regard to reproducibility and uniformity in the filling of multi-well microtiter plates with liquid media.

### SUMMARY

It is therefore a task of the present disclosure, per an embodiment, to at least partially overcome the disadvantages known from the prior art. In particular, it is a task per an embodiment to provide a device which permits reproducible filling of microtiter plates and can itself be filled easily. It is further an object of the present disclosure, per an embodiment, to provide a filling device for microtiter plates which is leak-proof during transport and which, in particular, prevents premature dispensing of filling solutions.

The task is solved, according to certain embodiments, by the features of the respective independent claims, directed to the device according to embodiments, the use according to the disclosure and the kit-of-parts according to the disclosure. Preferred embodiments, at least some, are indicated in the dependent claims, in the description or in the figures, whereby further features described or shown in the dependent claims or in the description or in the figures may individually or in any combination constitute an object of the disclosure, as long as the context does not clearly indicate the contrary.

According to an embodiment, a device for simultaneous filling of microtiter plate wells via centrifugal forces is provided, wherein the device comprises at least one flat attachment for a microtiter plate having one or more liquid reservoirs for filling one well of the microtiter plate per liquid reservoir. Each liquid reservoir has an upper filling opening for receiving a filling liquid, one or more lower filling nozzles for dispensing the filling liquid into the well of the microtiter plate, and a reservoir wall connecting the filling opening and the filling nozzle to one another, the filling nozzle being arranged eccentrically to the axis of symmetry of the microtiter plate well and eccentrically to the axis of symmetry of the filling opening of the filling device in a partial region of the reservoir wall.

Surprisingly, it has been found that, per at least some embodiments, uniform and gentle filling of microtiter plates can be achieved via the filling nozzle design according to the disclosure. Two main advantages are achieved by the asymmetrical orientation of the filling nozzles, per at least some embodiments. First, the medium is not dispensed directly into the center of symmetry of the corresponding microtiter plate well. Due to the lateral orientation of the liquid reservoir opening, the delivery takes place in the direction of the well wall, which is much gentler than delivery directly to the cell cultures in the center of the well, especially when supplying cell cultures with new medium. Surprisingly, it has been found that, per at least some embodiments, the lateral arrangement of the dispensing openings does not cause the medium, which is held in the liquid reservoir only by the surface tension of the medium, to “release” prematurely and flow out of the liquid reservoir, for example during filling of the device itself, during transport or when it is placed on the microtiter plate. Such behavior would actually be expected, since the force distribution is less favorable with an asymmetrical outlet opening than with a symmetrical orientation of the opening. Surprisingly, by means of the arrangement of the openings in the wall, it is also possible to use very low-viscosity media which, for example due to the addition of surface-active substances, have only an extremely low surface tension. In addition, the design of the device according to the disclosure allows sufficient quantities of medium to be applied per pass, so that adaptation to different numbers of wells is easily possible. A further advantage, per at least some embodiments, is that only slight centrifugal forces can be used to achieve very uniform simultaneous medium delivery from the individual liquid reservoirs, which can lead to only a small error in the time of medium addition when performing kinetic investigations.

The device according to the disclosure is suitable for simultaneous filling of microtiter plate wells by means of centrifugal forces. In particular, the device described is suitable for simultaneous delivery of a liquid medium into one or more wells of microtiter plates. For this purpose, the number of liquid reservoirs present in the filling device corresponds at least to the number of wells to be filled, with one liquid reservoir providing the required amount of medium for one well. The liquid reservoirs are arranged simultaneously on the wells to be filled and, via the application of centrifugal forces, an impulse can be imparted simultaneously to the liquids present in the reservoirs, whereby these are then driven out of the liquid reservoirs into the wells. For this purpose, for example, the microtiter plate with the device arranged thereon can be placed in a centrifuge, which exerts the appropriate momentum on the liquids by means of centrifugal forces. However, it is also possible that the necessary forces to expel the liquids are generated manually, for example by spinning the device. Furthermore, it is also possible that microtiter plate and device are arranged accordingly and the force is generated via a placement of microtiter plate and device. In this respect, the term centrifugal force also includes force applications which are not only directed towards or away from a center point. Preferably per at least some embodiments, however, the force is applied via a force directed towards or away from a center point, in the sense of the application of a centrifuge.

The device comprises at least one flat attachment for a microtiter plate, which has one or more liquid reservoirs for filling one well of the microtiter plate per liquid reservoir. The device according to the disclosure is thus adapted to the microtiter plate to be filled, whereby at this point it applies in particular that the number of liquid reservoirs corresponds to the number of wells to be filled. In the application of the device according to the disclosure, a liquid reservoir is arranged above the corresponding well to be filled. If several wells are present in the microtiter plate, the liquid reservoirs of the device are accordingly arranged above the microtiter plate in such a way that one liquid reservoir can fill one well of the microtiter plate in each case.

Each liquid reservoir has an upper filling opening for receiving a filling liquid, one or more lower filling nozzles for dispensing the filling liquid into the well of the microtiter plate, and a reservoir wall connecting the filling opening and the filling nozzle. The liquid storage device is configured to be filled with a filling liquid. Usually, the filling liquid is introduced into the liquid storage tank from above, through the corresponding filling opening. From above in this case means that the filling opening is located further away from the microtiter plate than the filling nozzle. At the “bottom” end of the device, there is one or more filling nozzles that dispense the filling liquid into the well of the microtiter plate after filling the liquid reservoir. The filling nozzle or nozzles may have a simple geometry, for example in the form of a round, square, rectangular or other cross-section. The filling nozzles need not necessarily have a constriction. The term “nozzle” in this case only says that there is an opening through which the filling liquid can flow. All liquids that can be used in connection with microtiter plates can be used as filling liquids. In this respect, it can be aqueous solutions or solutions of organic solvents. The filling liquid does not have to consist of these liquids, but can also contain other components that are normally used in laboratory liquids. These further components may be dissolved substances such as salts. However, it is also possible that a suspension or dispersion is used as the filling liquid, which additionally has “dissolved” substances in the liquid. The liquids may also have other additives, such as rheological aids, surfactants or buffer substances. The reservoir wall connects the lower part of the liquid reservoir with the filling nozzles to the upper part of the reservoir, which comprises the filling opening. In the case of an overall rotationally symmetrical design of the liquid reservoir, the result is a substantially cylindrically shaped wall which has filling nozzles in the cylinder jacket surface and not at the cylinder end face. The filling opening can be located on the opposite cylinder end face.

The filling nozzle is arranged eccentrically to the axis of symmetry of the microplate well and eccentrically to the axis of symmetry of the filling opening of the filling device in a partial area of the reservoir wall. Due to the fact that the microtiter plate wells usually have a rotationally symmetrical geometry, it may be useful for the filling device of the individual well to also have a rotationally symmetrical filling opening. In the case where the filling opening is circular in shape, the axis of symmetry results from the center of the circle of the filling opening. In this respect, it is not according to the disclosure if the filling nozzles for dispensing the filling liquid are arranged on the center vector of the filling opening, or parallel thereto. Overall, the filling nozzles are not located in the lower bottom region of the filling device, but are arranged such that the filling liquid is dispensed towards the side. The definitions of the side result from the indication that the filling nozzles are arranged in a partial area of the reservoir wall and not in the reservoir bottom. An arrangement in which the filling nozzles are arranged directly in the reservoir bottom and accordingly the filling liquid is discharged directly downwards is not according to the disclosure.

In an embodiment of the device, the reservoir wall of the liquid reservoir can be designed asymmetrically in the course from the filling opening to the filling nozzle, wherein at least in partial areas of the reservoir wall, wall areas at the same height distance from the filling opening have an angular difference of greater than or equal to 5° and less than or equal to 80° from one another. For improved and uniform filling of the liquid reservoir and at the same time also for safe storage of the filling liquid during transport in the device, it has proved particularly suitable that the course of the wall regions of the liquid reservoir is not symmetrical. In the alignment of the reservoir wall, there are differences in the alignment in the area of an equal distance to the filling opening. To determine the respective angles of the reservoir wall, one can imagine a plane parallel to the filling opening, which intersects the reservoir wall at a respective fixed distance from the filling opening. Due to the course of the wall at this distance from the filling opening, an angle can be determined in relation to the plane parallel to the filling opening which, according to the disclosure, is not the same for all sections of the reservoir wall at this height. This results in different areas in the reservoir wall which have a different gradient at the same height. An example for determining the slope and an example for the different slopes of the reservoir wall is shown in the figures. These different pitches of the reservoir walls have proven to be favorable, since it is possible to absorb and direct the forces acting on the liquid during filling of the liquid reservoir in a particularly gentle manner. As a result, premature leakage of the introduced liquid through the nozzles can be avoided. Furthermore, the angular orientation of the side walls can be used to define an active cross-section of the liquid reservoir, which influences the height of the liquid introduced. The height of the liquid column also essentially determines the pressure, which, in conjunction with the properties of the liquid and the size of the nozzle opening, dictates the force required for the liquid to exit the filling nozzle. Smaller angular ranges can be disadvantageous, since only too small effects are exerted by the angular differences that occur. Larger angles, on the other hand, can be disadvantageous because in these cases the cross-section of the filling device is narrowed too much.

Within an embodiment of the device, at least a partial area of the reservoir wall in the vertical course from the filling opening to the lower end of the liquid reservoir can have a constant angle with respect to the plane of the filling opening. In order to define a particularly suitable flow profile through the filling nozzles, it has been found to be suitable that at least a partial region of the reservoir wall has a constant orientation with respect to the plane of the filling opening. For example, this can be achieved by a partial region of the reservoir wall having a constant slope in the course from the filling opening to the lower end of the liquid reservoir. For example, the angle between this partial region of the reservoir wall and the plane of the filling opening may be greater than or equal to 60° and less than or equal to 110°. Further, the angle may be greater than or equal to 80° and less than or equal to 100°. Preferably, this partial region of the reservoir wall has an angle of 90° with respect to the plane of the filling opening in the perpendicular course from the filling opening to the lower end of the liquid storage tank. In this region, the reservoir wall is then aligned essentially parallel to the center point vector of the filling opening.

According to a preferred characteristic of the device, per an embodiment, at least one partial area of the reservoir wall can have two different angles in the vertical course from the filling opening to the lower end of the liquid storage tank with an angular difference of greater than or equal to 5° and less than or equal to 45°. For the gentle absorption of the filling liquid, it has been found to be particularly suitable that at least one partial area of the reservoir wall is designed in such a way that two sections are obtained which differ in their slopes. The differences in the slopes of the two sections are defined by the most different angles of the sections to each other. An example of the definitions of the angles is given in the figures. Within the indicated range of angles, partial sections can be constructed in the reservoir wall which can contribute to a suitable narrowing of the cross-section of the filling device. In addition to a suitable narrowing and thus control of the hydrostatic pressure of the liquid column, these angular differences in the partial sections can also be used in particular to pass quantities of liquid suitably into the lower region of the liquid reservoir, so that the risk of unintentional leakage of the filling liquid during the filling process can be reduced.

In a further embodiment of the device, at least one partial area of the reservoir wall in the vertical course from the filling opening to the lower end of the liquid reservoir can have three sections with different angles with an angular difference of greater than or equal to 5° and less than or equal to 85°. In the path from the filling opening to the lower end of the liquid reservoir, there are thus three different path sections which have different inclines relative to one another. The different gradients are defined in terms of their size by the different angles between the individual sections. An example of the angle differences is shown in the figures. Via the above defined ranges of the angular differences between the individual sections, on the one hand, the hydrostatic forces of the filling liquid on the filling nozzle can be adjusted. Furthermore, within these angular ranges, a particularly suitable discharge of the filling liquid during the insertion process into the lower area of the liquid reservoir can be achieved, so that the risk of an unintentional discharge of the filling liquid through the nozzle can be avoided. Furthermore, this embodiment can contribute to an improved residual emptying of the liquid reservoir. In particular, the design of the reservoir wall with three different sections with different angles may be suitable to be combined with a section which has only one slope. In particular, this one pitch can be 90° with respect to the plane of the filling opening.

Within an aspect of the device, per an embodiment, the filling nozzle or nozzles may be round or oval in shape and have a diameter greater than or equal to 0.01 mm and less than or equal to 2 mm. Within these size ranges of the nozzle opening, safe filling of microtiter plates can be achieved with a variety of different filling fluids. The liquids are held in the liquid reservoirs by surface tension alone and can be dispensed from the liquid reservoir by applying suitable centrifugal forces. The dispensing of the filling liquid from the liquid reservoir can take place within a very short period of time and simultaneously for all reservoirs of the device.

In a further embodiment of the device, the filling opening can have a substantially circular symmetry, with a recess being formed in a partial region of the circular circumference over a distance of greater than or equal to 5% and less than or equal to 25% of the circular circumference. In addition to an asymmetrical design of the walls of the liquid reservoir, it has also been found to be advantageous, per at least some embodiments, that a preferred direction in the filling is specified via the filling opening. For example, the filling opening can have a circular geometry, with a recess being provided in the circle. The recess can be used, for example, to apply a pipette to this recess. Preferably, per an embodiment, the recess can have a wedge-shaped geometry, which can lead to an improved attachment of the pipette tips. The above limits for the size of the recess have also been found to be suitable for fast and safe handling. If the recess is smaller than specified above, safe attachment of the pipette can only be carried out inadequately. If, on the other hand, the area of the recess is larger, the pipette can only be held insufficiently securely at a fixed position of the recess. An essentially circular geometry results in cases where the area differences between a circle applied to the nozzle opening and the nozzle opening itself are less than or equal to 15%.

Within a further embodiment of the device, the recess can include an angle in the plane of the filling opening of greater than or equal to 140° and less than or equal to 220° with respect to the partial area of the reservoir wall having different angular gradients. In this embodiment, the position of the recess may be opposite the portion of the reservoir wall having sections with different slopes. In particular, this may be equivalent to the recess being located above the portion of the wall which has a continuous, 90° course with respect to the plane of the filling opening. In this embodiment in particular, a particularly simple and reproducible filling of the liquid reservoir can be made possible. The pipette can be applied more easily in a preferred direction to the liquid reservoir through the recess, whereby the different angles of the opposite wall of the liquid reservoir enable a particularly reproducible discharge of the liquid into the lower area of the filling device. The hydrostatic forces occurring during filling can be directed in a targeted manner, and in this way the risk of unintentional leakage of the liquid from the laterally attached nozzle can be reduced. It can also be advantageous, per an embodiment, that the angled reservoir wall is opposite the recess, i.e. encloses an angle of 180° with it.

Within a further aspect of the device, per an embodiment, the device may include a circumferential elastic sealing ring at each filling opening. The sealing ring may be particularly useful in cases where the filling device is not used for dispensing but for receiving culture medium, for example in the context of a medium change. The device can then be placed with the respective openings on the corresponding well openings and ensure a gas- and air-tight connection to the wells via the circumferential sealing ring. The liquid can then be safely centrifuged from the wells into the device via a centrifugation step, for example. An escape of aerosols into the centrifuge chamber can thus be prevented. Alternative devices for sealing the filling device are also conceivable, for example the application of a deformable polymer to the contact surfaces between the microtiter plate and the filling device.

According to a characteristic of the device, per an embodiment, the device may include a circumferential sealing lip made of a resilient material. The circumferential sealing lip can encompass the entire device and help to ensure that the device can be connected in a gas-tight and liquid-tight manner to additional containers, such as a collection tray. This can facilitate the filling process and the change of culture medium. In particular, the sealing surface can be arranged externally on the surfaces of any inner and outer walls of the filling device, including the outer wall to the inner wall of a cover plate/lid.

The use of a device according to an embodiment for filling microtiter plate wells with a liquid medium is also in accordance with the disclosure. The device according to at least some embodiments can have particular advantages, especially in the area of handling and filling of microtiter plates. The preparation for filling can be decoupled from the handling of the microtiter plate. For example, the filling of the device can be performed independently of the actual experiment in the microtiter plate. This can be particularly advantageous, per embodiments, in cases where the microtiter plate must be exposed to constant environmental conditions. The filling of the device can be done externally, for example by a separate filling with filling liquid into the liquid reservoirs. Due to the design of the liquid reservoirs and in particular also due to the design of the filling opening, simple and safe handling during filling can be achieved, for example by using conventional pipettes. The forces occurring during filling are safely diverted by the shape of the reservoir walls, so that even in the event of fluctuations in the forces occurring during filling, leakage of the filling liquid through the laterally arranged filling nozzles can be prevented. The individual liquid reservoirs of the device are filled and the addition of the liquids into the individual wells of the microtiter plates can be carried out by placing the device on the microtiter plate. Here, one liquid reservoir at a time is arranged on a well of the microtiter plate. This can be achieved by the number of liquid reservoirs and their arrangement on the device corresponding to the number of wells on the microtiter plate and their arrangement. The combination of the microtiter plate and the attachment of the device of the invention can then be transferred to a centrifuge, for example. By applying centrifugal forces, the filling liquid can be transferred from the respective liquid reservoir to the well of the microtiter plate. The special design of the liquid reservoir results in a simultaneous, uniform and gentle transfer of the liquid into the well of the microtiter plate. In particular, the lateral arrangement of the nozzle opening causes the jet of the filling liquid to first target the walls of the well. In this respect, cell cultures, for example, are protected, since the supply of liquid is not directed directly onto the cell cultures, but onto the well walls. In this respect, the filling liquids may be cell culture media in particular. Preferably, per embodiments, the filling fluids in may have a viscosity at 25° C. of greater than or equal to 0.5 mPas and less than or equal to 100 mPas, preferably of greater than or equal to 0.75 mPas and less than or equal to 25 mPas. The fluids to be filled may be Newtonian fluids, for example.

In a further embodiment of use, the device may already be filled with a culture medium. For such use, nozzle attachments can be provided into which a liquid to be added to the microtiter plates is already placed in the attachments and immobilized via various means for transport purposes. For example, reversible closure of the upper nozzle opening may be provided, e.g., by a self-adhesive film. In addition, reversible closure of the lower nozzle opening can be provided by a self-adhesive, peelable film. Alternatively, however, it is also possible to stably immobilize the liquid in the nozzles by freezing it. The adhesive film can then be removed or the liquid thawed before actual use.

Further according to an embodiment, a kit-of-parts is at least comprising a device according to the disclosure, a device cover plate, and a receptacle for liquids. A particularly suitable vending form may include the device according to the disclosure and a cover plate. The cover plate may be particularly suitable for allowing the filling openings of the device according to the disclosure to be closed after filling. The cover plate enables the filling openings to be closed in a sterile and/or gas-tight manner. This can further help to prevent unintentional leakage of liquid from the filling nozzles. In addition, aerosols may be prevented from escaping through the filling nozzles. Furthermore, it may be convenient for the kit to include a receptacle for liquids. The receptacle for liquids may be particularly suitable for receiving liquids that are dispensed from the microtiter plate wells. For example, the symmetry of the receptacle for liquids may correspond to the symmetry of the microtiter plate. Thus, in particular, the receptacle for liquids may serve to receive the liquid already present in the microtiter plate prior to the addition of a new medium through the use of the device according to the disclosure. In these cases, the uptake can be performed as a function of the individual wells, so that the amounts of liquid from the individual wells can also be specifically examined in the uptake vessel. The transfer of the liquid from the wells of the microtiter plate to the respective matching part of the receptacle for liquids can be done by simple shaking and or by a centrifugation step. This can be achieved, for example, by matching the receptacle for liquids to the microtiter well openings so that it can be inserted flush there and seals. The dimensions of the receptacle for liquids thus correspond to the internal dimensions of the well. In this case, the nozzle geometry of the attachment according to the disclosure prevents the liquid from splashing back into the emptied wells through the non-symmetrical opening during centrifugation. The edge of the rim can be angled inward so that the liquid is directed into the opening and flows well out into the filling nozzle and eventually into an empty, for example, a 384-well plate. Alternatively, the receptacle for liquids with the nozzle geometry according to the disclosure can be used without a nozzle opening(s), in which case the liquid removed from the wells of the microtiter plate is collected in the liquid reservoir without nozzle opening(s) or with the nozzle opening(s) of the receptacle for liquids closed. In this case, the described nozzle geometry then enables particularly good immobilization of the liquid, since the downwardly narrowing cross-section holds the liquid more firmly via the surface tension. The slanted side wall and the opposite vertical side wall also make it easier to attach a pipette laterally via the side of the slanted side wall (as opposed to using the liquid reservoir as a nozzle), especially in cases where liquid is to be removed for sampling. The notch in the filling opening, shown for example in FIG. 6, can then, in contrast to the use of the liquid reservoir as a nozzle, be placed on the opposite side indicated for filling. For example, not on the side of the vertical reservoir wall, but on the opposite sloping wall, so that it is easier to attach a pipette laterally for sampling even from deeper areas of the closed nozzle.

In a further embodiment, the removed liquid may be immobilized on the bottom of the receptacle for liquids. The means for immobilizing the liquid may be an absorbent matrix and/or, in the direction of the attached microtiter plate wells, a columnar honeycomb structure. By absorption of the liquid in the matrix and/or by a suitable holding by capillary forces, the liquid taken from the microtiter plate can be fixed in the receptacle for liquids. The combination of the device according to the disclosure, the cover plate and the receptacle for liquids can ensure a particularly fast and efficient exchange of a liquid medium in microtiter plates.

In an embodiment of the receptacle for liquids, it may be in the form of a rectangular or square tub. The tub can also have a sealing lip made of an elastic material, such as silicone, on the upper edge or on the inner wall edge. The sealing lip can ensure an airtight and liquid-tight connection of the collection vessel when the microtiter plate is in place. An absorbent material may also be fixed to the bottom of the well. Suitable materials include, for example, cellulose, modified celluloses, superabsorbents or other materials which are suitable for absorbing culture fluids from microtiter plates and are characterized in particular by rapid fluid absorption and high absorption capacity. This overall embodiment may be adapted to allow quick and easy replacement of the culture fluid. The microtiter plates can be inserted into the receptacle for liquids with the openings facing the bottom of the well and sealed airtight against the ambient air via the sealing lip. If necessary, this construct can be mechanically stabilized by additional holders or clamps. The liquid from the microtiter plates can then be centrifuged precisely onto the absorbent material without the risk of liquid escaping from the device. In particular, this form of embodiment can prevent cell culture medium from escaping during acceleration, especially of the hanging rotors in the centrifuge. During the acceleration process, the rotors only reach a position parallel to the axis of rotation/perpendicular to the rotor axis at higher rotational speeds and higher radial forces, which allow liquid to escape directly toward the rotor axis. However, since the surface tension of the liquid is already overcome by the radial force at an earlier point in time at lower rotational speed, during which the swivel rotor is not yet completely aligned perpendicular to the rotor axis due to the still higher gravity, the liquid is not conveyed out directly in a liquid outlet directed in the rotor axis, but, additionally due to the acceleration against the direction of rotation, is also deflected upwards in the direction of the centrifuge opening. Due to the design of the collecting tray, this unintentional liquid discharge can be prevented and the liquid from the microtiter plates can be directed precisely and safely onto the absorbent material. The liquid absorbed on the absorbent material can later be examined with spatial accuracy as a function of the individual well. Direct contact with the absorbent matrix should be aimed for, whereby the openings of the microtiter plate can also be manually pressed a little into the deformable matrix in order to achieve a good seal between the individual microtiter plate wells.

Within a further embodiment, the liquid change of a microtiter plate can also be performed via the filling device according to the disclosure. The filling device according to the disclosure can be placed with the filling opening on the opening of the wells. This results in a different use of the filling device when changing the medium, since it is placed “upside down” on the microtiter plates. In this embodiment, it can be helpful if a sealing ring is provided on the upper edge of each filling device, which engages at least partially in the opening of the microtiter plate and seals the well-filling device connection in an air- and liquid-tight manner. Alternatively, this sealing can also be achieved by a sealing intermediate layer which leaves the well openings unsealed in each case. Alternatively, the geometry of the sealing matrix can also already be created in such a way that a pyramid-like protrusion into the individual wells is already preformed and the earliest possible immobilization in the wells is further ensured during the centrifugation of the liquid. Centrifugation then transfers the liquid from the wells to the filling device. In these cases, the filling device can be closed at the other side by suitable measures so that the liquid is stored in the filling device. Alternatively, it is also possible to arrange a further absorbent layer above the filling device so that the liquid is then ultimately stored in this layer. For this use of the filling device, it can be helpful that the filling device as a whole is made of an elastic material. Alternatively, the filling device may continue to have an open lower nozzle opening when the nozzles of the device are appropriately positioned into an acceptor microtiter plate. A sufficient contact pressure to seal the “upside down” positioned filling device well with the microtiter plate together can be achieved, for example, by using a corresponding cassette. The cassette can, for example, have a screw device which exerts a corresponding equally distributed pressure on the microtiter plate(s) and the filling device so that a mechanically stable connection is temporarily obtained.

### BRIEF DESCRIPTION OF THE FIGURES

Further advantages and advantageous embodiments of the objects according to the disclosure are illustrated by the drawings and explained in the following description. It should be noted that the drawings are descriptive only and are not intended to limit the disclosure.

It Shows:

FIG. 1a schematic embodiment of a device according to the disclosure;

FIG. 2 a schematic cross-sectional view of a fluid reservoir according to the disclosure;

FIG. 3 a schematic side view of a fluid reservoir according to the disclosure;

FIG. 4 a schematic design of a liquid reservoir according to the disclosure, viewed from above the filling opening;

FIG. 5a schematic embodiment of a fluid reservoir according to the disclosure in side view;

FIG. 6a schematic embodiment of a liquid reservoir according to the disclosure, viewed from above the filling opening.

### DETAILED DESCRIPTION

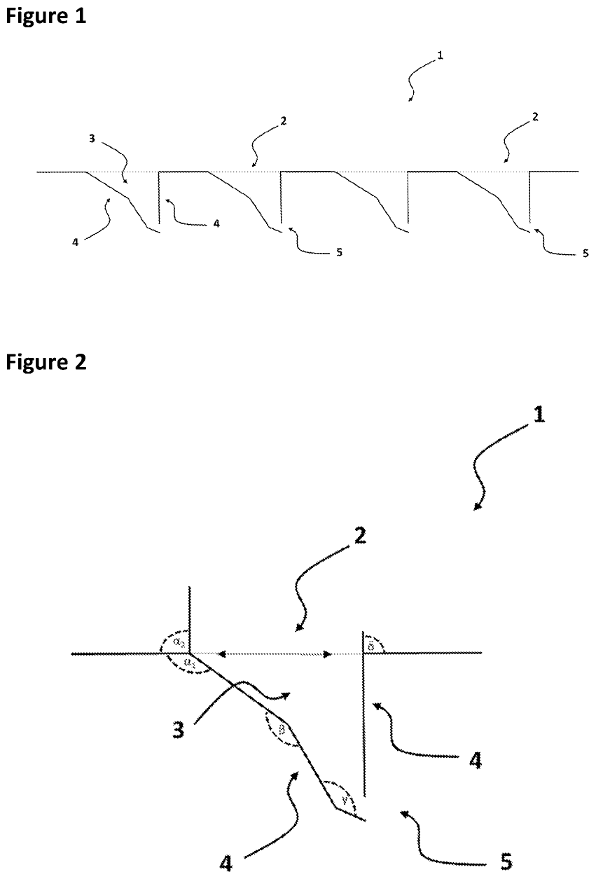

FIG. 1 shows a schematic embodiment of a device 1 according to an embodiment of the disclosure in a cross section view. The device 1 may have a flat surface from which the individual liquid reservoirs 3 extend downward. In this orientation, the device 1 according to the embodiment would be placed, for example, on a microtiter plate (not shown in this figure). In this figure, in addition to the liquid reservoirs 3, the individual filling openings 2 through which the liquid reservoirs 3 are filled with a medium can also be seen. In this sectional view, the different course of the reservoir wall 4 is also shown. In this example it is shown that a reservoir wall 4, in this example the right reservoir wall, has only a continuous increase in the course from the filling opening 2 to the filling nozzle 5. Another portion of the reservoir wall 4 shows an angled design, with different portions of this reservoir wall portion having a different slope. According to the embodiment, the filling nozzle 5 is designed in such a way that the liquid is not discharged directly downwards, but to the side. In this respect, the filling nozzle 5 is arranged in a partial area of the reservoir wall 4. In particular, the filling nozzle 5 is arranged asymmetrically and off-center with respect to the axis of symmetry of the filling opening 2. Due to the lateral arrangement of the filling nozzle 5, the liquid is dispensed into the well of a microtiter plate not directly frontally, but likewise to the side wall of the well. In particular, this can make the application of the medium more gentle so that, for example, in the case of a medium change in cell cultures, the cell cultures are not brought into contact with the medium frontally. The medium first hits the walls of the well of the microtiter plate and is only then brought into contact with the cell cultures.

FIG. 2 shows a schematic embodiment of a liquid reservoir 3 in section. In this embodiment, the different course of the reservoir walls 4 can be seen. The course of the reservoir wall 4 is described in section perpendicular to the surface of the filling opening 2. In this embodiment it can be seen that a part of the reservoir wall 4, in this figure the right part of the reservoir wall 4, runs perpendicularly with respect to the plane of the filling opening 2. The angle δ between the surface of the filling opening 2 and the course of the reservoir wall 4 is approximately 90° in this embodiment. The wall section 4 opposite in section, the left wall section 4, has an angled course with three different gradients. The individual angles between the sections are indicated in the figure. The angled routing of the reservoir wall 4 can be used to specify both the height of the liquid column during a filling operation and the forces that occur when the filling liquid is introduced into the lower part of the liquid reservoir 3. In this respect, the angled design can be used to adjust the simplicity of expelling the filling liquid from the liquid reservoir 3 very precisely.

FIG. 3 shows a schematic embodiment of a liquid reservoir 3 in side view. In this figure, an embodiment is shown in which the opposing wall sections 4 of the liquid reservoir 3 run parallel to each other and at an angle of approximately 90° with respect to the filling opening 2. The outlet nozzles 5 are not arranged on the underside of the liquid reservoir 3, but extend to one of the sides of the liquid reservoir 3. In this respect, they are arranged in the edge regions of the liquid reservoir 3. In this embodiment, it is shown that the single fluid reservoir 3 has a plurality of filling nozzles 5. The individual nozzles are arranged in the wall 4 of the fluid reservoir 3. Furthermore, in this embodiment it can be seen that the filling opening 2 comprises a recess 6. The recess 6 may, for example, be a wedge-shaped recess. Furthermore, it may be particularly advantageous that the recess 6 is arranged on the same side as the nozzle openings 5.

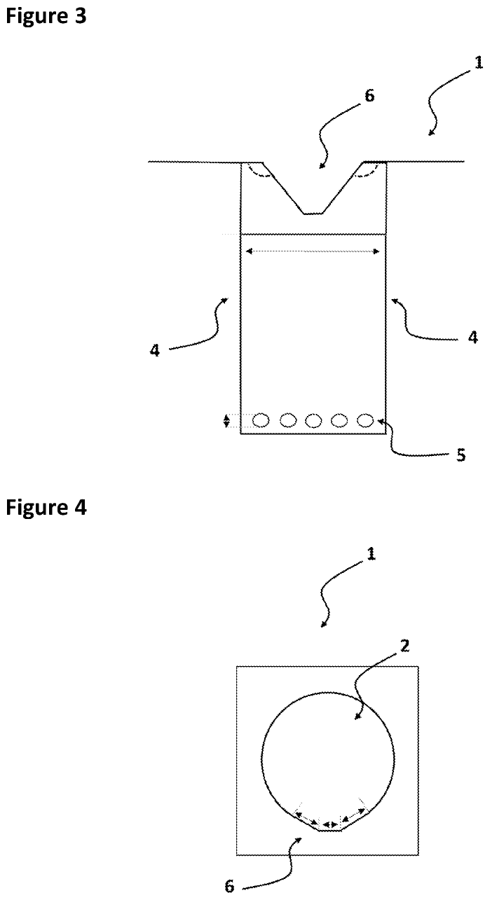

FIG. 4 shows a schematic embodiment of a liquid reservoir 3 in a top view of the filling opening 2. In this embodiment, it is shown that the filling opening 2 has an essentially circular symmetry. At one point of the filling opening 2, a recess 6 is provided, wherein in this area the routing of the filling opening 2 deviates from the circular geometry. This recess 6 can, in particular, facilitate the placement of a pipette tip, whereby, in addition to facilitating the placement, the liquid flow can also be predetermined during the introduction of the filling liquid. In particular, this can contribute to safe and improved filling with a suitable routing inside the liquid reservoir 3.

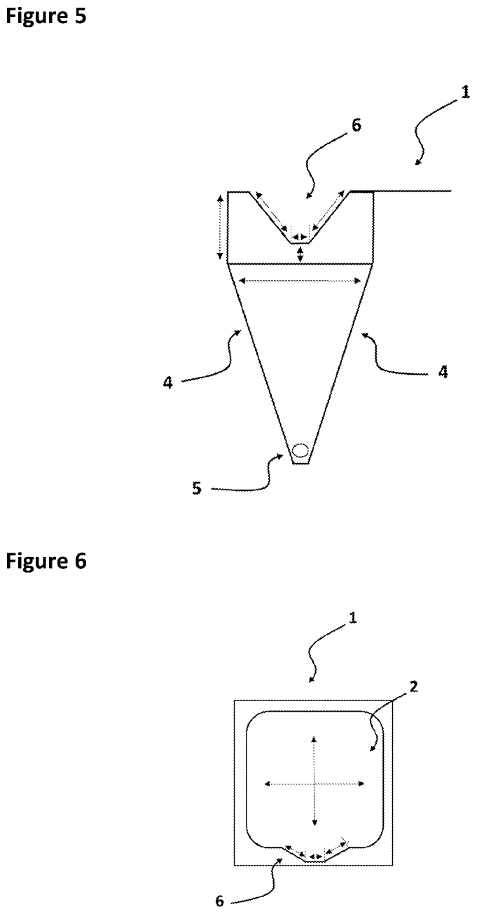

FIG. 5 shows a schematic embodiment of a fluid reservoir 3 in side view. A similar view is shown in FIG. 3. In contrast to FIG. 3, only one outlet nozzle 5 is present here. In addition, the liquid reservoir 3 has an overall conically guided geometry. The outer upper nozzle dimensions can match the dimensions of the annular filling opening 2 and these can taper downwards.

FIG. 6 shows a schematic design of a liquid reservoir 3 in accordance with the embodiment, viewed from above the filling opening 2. As an alternative, it is shown here that the filling opening 2 has a square shape. The notch 6 can also be seen in this design, which facilitates the targeted application of a pipette tip.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. Device for simultaneous filling of microtiter plate wells by means of centrifugal forces, at least comprising a flat attachment for a microtiter plate having one or more liquid reservoirs for filling in each case one well of the microtiter plate per liquid reservoir, wherein each liquid reservoir having an upper filling opening for receiving a filling liquid, one or more lower filling nozzles for dispensing the filling liquid into the well of the microtiter plate, and a reservoir wall connecting the filling opening and the filling nozzle to one another, wherein the filling nozzle is arranged eccentrically to the axis of symmetry of the microtiter plate well and eccentrically to the axis of symmetry of the filling opening of the filling device in a partial region of the reservoir wall.

2. Device according to claim 1, wherein the reservoir wall of the liquid reservoir is designed asymmetrically in the course from the filling opening to the filling nozzle, wherein at least in partial regions of the reservoir wall, wall regions at the same height distance from the filling opening have an angular difference of greater than or equal to 5° and less than or equal to 80° from one another.

3. Device according to claim 1, wherein at least a partial area of the reservoir wall in the vertical course from the filling opening to the lower end of the liquid reservoir has a constant angle with respect to the plane of the filling opening.

4. Device according to claim 1, wherein at least a partial area of the reservoir wall has two different angles in the vertical course from the filling opening to the lower end of the liquid storage tank with an angular difference of greater than or equal to 5° and less than or equal to 45°.

5. Device according to claim 1, wherein at least a partial area of the reservoir wall in the vertical course from the filling opening to the lower end of the liquid reservoir has three sections with different angles with an angular difference of greater than or equal to 5° and less than or equal to 85° in each case.

6. Device according to claim 1, wherein the filling nozzle or the filling nozzles are round or oval in shape and have a diameter greater than or equal to 0.01 mm and less than or equal to 2 mm.

7. Device according to claim 1, wherein the filling opening has a substantially circular symmetry, wherein a recess is formed in a partial region of the circumference of the circle over a distance of greater than or equal to 5% and less than or equal to 25% of the circumference of the circle.

8. Device according to claim 7, wherein the recess includes an angle in the plane of the filling opening of greater than or equal to 140° and less than or equal to 220° with respect to the partial area of the reservoir wall having different angular gradients.

9. Use of a device according to claim 1 for filling microtiter plate wells with a liquid medium.

10. A kit-of-parts at least comprising a device according to claim 1, a device cover plate, and a receptacle for liquids.
